(19) United States
(12) Patent Application Publication
(10) Pub. No.: US 2020/0363120 A1
(43) Pub. Date: Nov. 19, 2020

(54) HEATED PORTAL FRAME FOR ORDER DISPENSATION PORTAL

(71) Applicant: Walmart Apollo, LLC, Bentonville, AR (US)

(72) Inventor: Boyd D. Bryant, Bella Vista, AR (US)

(21) Appl. No.: 16/877,171

(22) Filed: May 18, 2020

Related U.S. Application Data
(60) Provisional application No. 62/849,950, filed on May 19, 2019.

(51) Int. Cl. F25D 21/04; H05B 1/02; H05B 3/00; B65G 1/06; G07F 17/00

(52) U.S. Cl. CPC F25D 21/04; H05B 1/0202; G07F 17/0078; B65G 1/06; H05B 3/0014

(57) ABSTRACT

Examples provide a heated portal frame associated with an order dispensation portal for dispensing a set of items to a user. The heated portal frame includes a metallic framework forming a horizontal surface defining at least one tote access portal. Each tote access portal defined by the metallic framework is associated with a recessed tote compartment configured to support at least one tote storing a set of item beneath the metallic framework. The heated portal frame includes a set of resistance heating elements associated with at least a portion of the portal frame. The resistance heating element(s) warm the frame to increase a temperature of an exterior surface of the portal frame in contact with ambient exterior air. The heating element(s) can be located beneath the frame or embedded within the frame to prevent condensation forming on the portal frame.

### BACKGROUND

Currently, when a customer orders grocery items online, the customer typically waits for the items to be delivered or travels to a brick-and-mortar store location to pick-up the items. To pick-up the items, the customer typically has to go inside the store and wait for the items to be brought out. In some solutions, the customer can go through a drive-through pickup area or park in a pickup area and wait for the items to be brought out to the customer. If grocery items are chilled or frozen items, storage and delivery of the items has to take into account cooling/refrigeration of the items during order fulfillment and delivery. As the number of online orders increases, the logistics of maintaining chilled and frozen items prior to pick-up or delivery to each customer can become complex, inefficient and time-consuming.

### SUMMARY

Some examples provide a system for maintaining temperature of an exterior surface of a portal frame associated with an automatic order dispensation portal for pickup of ordered items. An order dispensation portal dispenses a set of totes within an order pickup alcove enclosed by a set of automatic sliding doors. The automatic sliding doors slide open to permit user access to contents of the set of totes. A portal frame forms a horizontal surface defining a set of tote access portals associated with the set of totes resting within a set of recessed tote compartments. The portal frame prevents removal of a tote in the set of totes from a recessed tote compartment while permitting removal of tote contents. Insulation associated with at least a portion of the order dispensation portal insulates the order dispensation portal against cooled air from an interior temperature-controlled cooler area adjacent to the order dispensation portal. A set of resistance heating elements associated with at least a portion of the portal frame control temperature of an exterior surface of the portal frame in contact with ambient exterior air. The set of resistance heating elements prevent condensation from forming on the exterior surface of the portal frame.

Other examples provide a method for heating a portal frame associated with an order dispensation portal. A set of resistance heating elements are attached to at least a portion of the portal frame. The resistance heating elements heat at least a portion of an exterior surface of the portal frame in contact with ambient exterior air to prevent condensation from forming on the portion of the portal frame coming into contact with the ambient exterior air. Temperature of the portal frame is adjusted to maintain temperature within a threshold temperature range.

Still other examples provide a heated portal frame associated with an order dispensation portal for dispensing a set of items to a user. The heated portal frame includes a metallic framework forming a horizontal surface defining a set of tote access portals. Each tote access portal is associated with a recessed tote compartment beneath the metallic framework configured to secure at least one tote comprising a set of items. A set of resistance heating elements are associated with at least a portion of the portal frame configured to increase a temperature of an exterior surface of the portal frame in contact with ambient exterior air. The set of resistance heating elements prevents condensation on the portal frame due to cooled air from an interior temperature-controlled area adjacent to the order dispensation portal.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a heated portal frame.

FIG. 2 is an exemplary block diagram illustrating an order dispensation portal including a heated portal frame.

FIG. 3 is an exemplary block diagram illustrating an order dispensation portal including a heated portal frame associated with a set of totes.

FIG. 4 is an exemplary block diagram illustrating a heated portal frame defining a set of tote access portals.

FIG. 5 is an exemplary block diagram illustrating a heated portal frame including a temperature sensor.

FIG. 6 is an exemplary block diagram illustrating an order dispensation portal having open automatic sliding doors exposing a portal frame to exterior ambient air.

FIG. 7 is an exemplary block diagram illustrating a portal frame defining three tote access ports.

FIG. 8 is an exemplary block diagram illustrating a heated portal frame defining a tote access portal.

FIG. 9 is an exemplary block diagram illustrating a side view of a heated portal frame.

FIG. 10 is an exemplary block diagram illustrating a system for maintaining temperature of a portal frame within a threshold temperature range.

FIG. 11 is an exemplary flow chart illustrating operation of the computing device to automatically adjust temperature of a portal frame to prevent condensation.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Referring to the figures, examples of the disclosure enable heating of a portal frame within an order pickup alcove adjacent to a cooled tote storage area to prevent condensation forming on the exterior surface of the support frame coming into contact with warmer ambient air within the order pickup alcove.

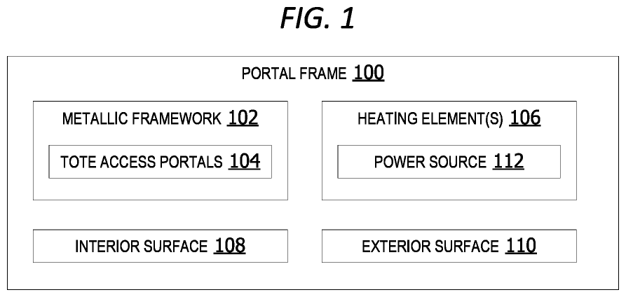

Referring again to FIG. 1, an exemplary block diagram illustrating a heated portal frame 100 is shown. The portal frame 100 in some examples is a metallic framework 102 defining a set of one or more tote access portals 104. Each tote access portal is associated with a recessed tote compartment beneath the metallic framework 102. The metallic framework 102 can be composed of any suitable metal, such as, but not limited to, steel, a composite metal and/or a metal matrix composite (MMC).

A set of one or more heating element(s) 106 is associated with at least a portion of the portal frame 100. The heating element(s) 106 can be embedded within the portal frame 100, attached to a portion of an interior surface 108 of the portal frame 100, or otherwise in contact with the portal frame 100. The interior surface 108 is the underside of the portal frame 100 which is in contact with cooled air from an interior of a tote storage area.

In other examples, the heating element(s) are located in close proximity to the portal frame to increase a temperature of an exterior surface 110 of the portal frame 100 in contact with outside ambient exterior air. The heating element(s) prevent condensation on the portal frame 100 forming from cooled air coming from an interior temperature-controlled area adjacent to an order dispensation portal.

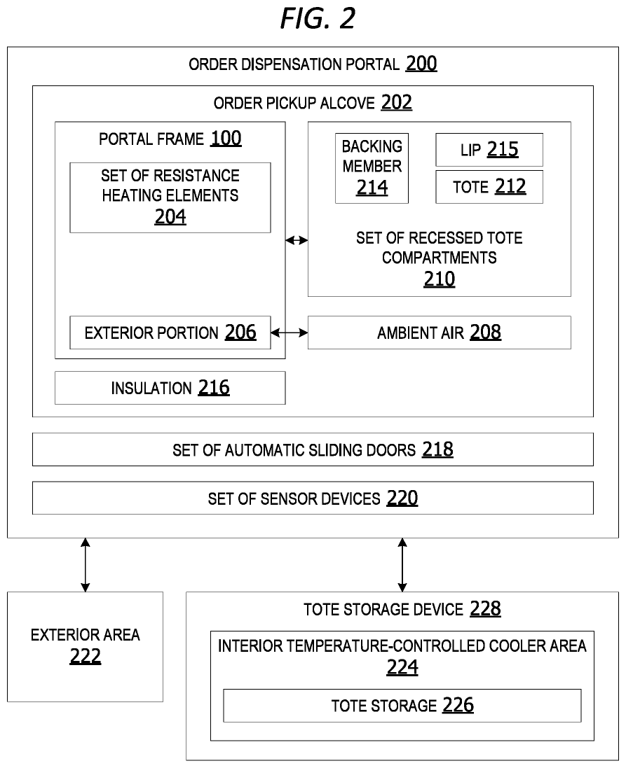

FIG. 2 is an exemplary block diagram illustrating an order dispensation portal 200 including a heated portal frame 100. The order dispensation portal 200 is an automated tote dispensing portal where a user can retrieve/pickup items ordered from a store or online order, such as items ordered via a website or application.

The order dispensation portal 200 in some examples includes an order pickup alcove 202. The order pickup alcove 202 is a recess in a wall containing the portal frame 100.

The portal frame 100 includes a set of resistance heating elements 204, such as, but not limited to, the heating element(s) 106 in FIG. 1. A power source 112 provides power, such as, but not limited to, an electric current, to the heating element(s) 106. The power source can include, without limitation, a set of electrical wires, a battery, a solar power generator, or any other type of power source.

The set of resistance heating elements 204 provides heat to warm/increase the temperature of the exterior portion of the portal frame 100 in contact with ambient air 208, which may be warmer than the cooled interior air within the interior temperature-controlled cooler area 224 within a tote storage device 228.

The tote storage device 228 is an automated storage and retrieval device for storing a plurality of totes, such as, but not limited to, the tote 212. Some of the totes in the tote storage device 228 store items waiting for pickup by users. Other totes in the tote storage device 228 can be empty totes. The interior of the tote storage device contains cooled/chilled air to maintain cold-chain compliance of chilled and/or frozen items within the totes. Chilled items can include, for example but without limitation, ice cream, milk, butter, etc.

The air inside the interior temperature-controlled cooler area 224 is in contact with the interior surface of the portal frame. The exterior air in contact with the portal frame is not temperature-controlled. Therefore, the ambient/exterior air entering the order pickup alcove 202 from the exterior area 222 outside the order dispensation portal 200 may be warmer than the interior cooled air. This can result in condensation on the portal frame 100. The set of resistance heating elements 204 warm the portal frame 100 to prevent the condensation from forming.

The order pickup alcove 202 in other examples includes a set of recessed tote compartments 210 for storing a set of one or more totes. A recessed tote compartment in the set of recessed tote compartments 210 is a recessed area beneath the portal frame 100 for storing/holding a tote 212. A tote 212 is a storage tote or other container for holding a set of items.

A recessed tote compartment in this example includes a lip 215 that overlaps with a rim of the tote 212 to prevent the tote 212 from being lifted vertically out through the tote access portal. The lip 215 prevents removal of the tote 212 while enabling a user standing within the order pickup alcove to remove the items/contents of the tote through the tote access portal.

A backing member 214 is a panel, flap or other member that prevents the tote 212 from sliding backwards out of the recessed tote compartment. The backing member 214 in some examples is attached to an underside of the portal frame 100. In other examples, the backing member 214 is attached to one or more sides of the recessed tote compartment.

Insulation 216 within the order dispensation portal 200 is provided in some examples as additional protection against condensation. The insulation 216 can be provided within the walls of the order pickup alcove 202 and/or around a portion of the set of recessed tote compartments 210.

The order pickup alcove 202 in some examples is closed off by a set of automatic sliding doors 218. The set of automatic sliding doors 220 opens when a set of totes containing one or more items for pickup by a user is in place within the set of recessed tote compartments 210. When the sliding doors are open, the user/customer is able to enter the order pickup alcove and remove the item(s) from the set of totes via the tote access portals created by the portal frame 100.

A set of sensor devices 220 can optionally be included. The set of sensor devices 220 can include a set of one or more scan devices, a set of one or more image capture devices, a set of one or more optical sensors, a set of one or more pressure sensors, etc. An image capture device can be implemented as a camera, an infrared sensor, an optical imaging device or any other type of image capture device.

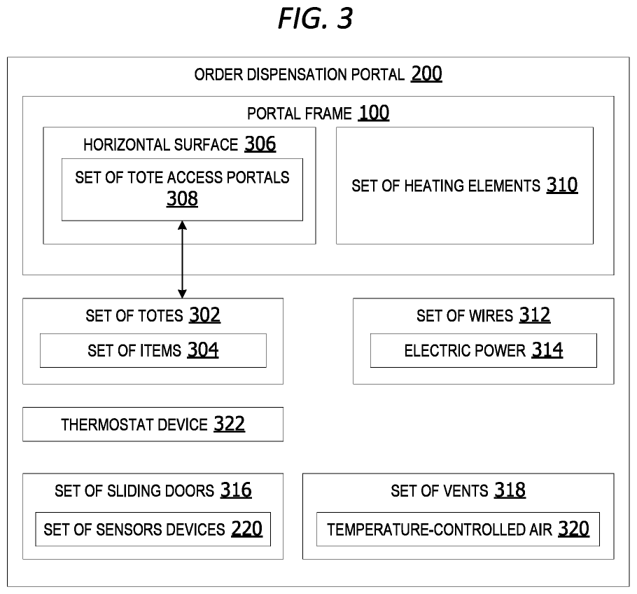

FIG. 3 is an exemplary block diagram illustrating an order dispensation portal 200 including a heated portal frame 100 associated with a set of totes 302. The set of totes 302 includes one or more totes for storing a set of one or more items 304, such as, but not limited to, the tote 212 in FIG. 2.

The portal frame 100 in this example creates a horizontal surface 306 defining a set of tote access portals 308. The set of tote access portals 308 includes one or more portals associated with one or more recessed tote compartments.

A set of heating elements 310 includes one or more heating elements, such as, but not limited to, the heating element(s) 106 in FIG. 1 and/or the set of resistance heating elements 204 in FIG. 2. The set of heating elements 310 in this example receive electric power 314 via a set of wires 312.

A set of sliding doors 316 enclosing the portal frame within an order pickup alcove in this example includes the set of sensor devices 220 generating sensor data, associated with the sliding doors. The sensor data indicates whether the doors are obstructed by a human user or an object. If the doors are obstructed, they remain open. If the doors are unobstructed, they close automatically after the user has removed all the items from the set of totes 302.

The order dispensation portal 200 in other examples can also include a set of one or more vents 318. The set of vents 318 provide a flow of temperature-controlled air 320 into the order dispensation alcove to assist with preventing condensation on the portal frame 100, the set of sensor devices 220, the set of sliding door and/or other devices within the order dispensation portal 200.

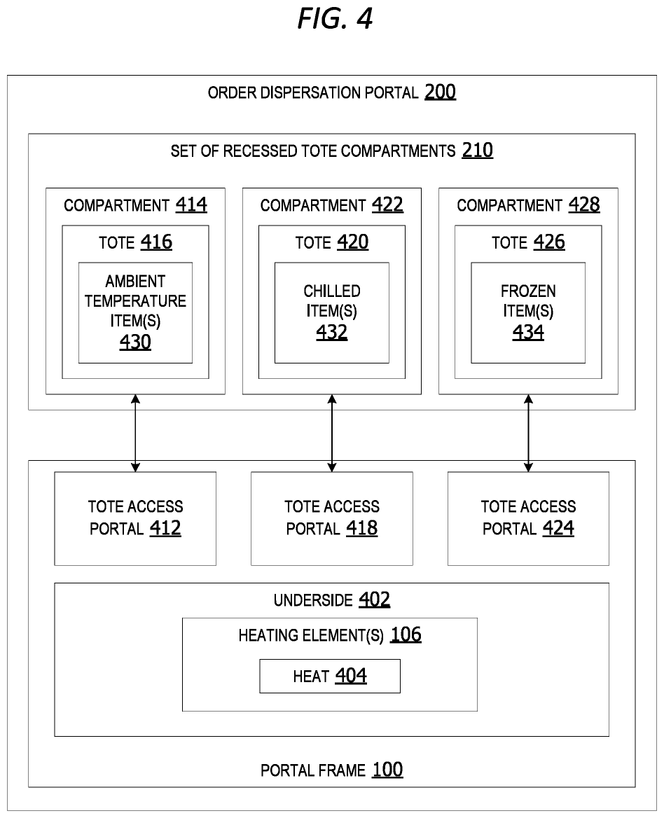

FIG. 4 is an exemplary block diagram illustrating a heated portal frame 100 defining a set of tote access portals. The portal frame 100 includes a set of heating element(s) 106 attached to an underside 402 of the portal frame which is not visible to a user removing items from a set of totes within the order dispensation portal 200. The heating element(s) 106 generate heat 404 to increase the temperature of the portal frame 100.

The portal frame defines a set of tote access portals associated with a set of recessed tote compartments 210 associated with a set of totes storing a set of items for pickup by user. In this example, the tote access portal 212 is a portal enabling a user to remove items from a tote 216 within a recessed tote compartment 214. The tote access portal 218 is a portal within the portal frame 100 enabling a user access to the contents of the tote 220 in the corresponding tote compartment 222 below the portal frame. Likewise, the tote access portal 224 enables a user to remove items from the tote 226 within the compartment 228 beneath the tote access portal 224 without being able to move or remove the tote 226.

In this example, the set of totes includes three totes in a set of three recessed tote compartments. However, the examples are not limited to three totes. The examples can also include a single tote in a single recessed tote compartment, two totes in two recessed tote compartments, as well as four or more totes in four or more recessed tote compartments.

In this example, the set of tote access portals includes three tote access portals associated with a set of three totes. However, the examples are not limited to three tote access portals within the portal frame 100. In other examples, the portal frame includes a single tote access portal, two tote access portals, as well as four or more tote access portals.

The set of totes store one or more items. The items can be individual, un-bagged items or items in one or more bags, boxes or other wrappings. The items within a tote can be one or more ambient (room) temperature item(s) 430, one or more chilled item(s) 432 or one or more frozen item(s) 434. In this example, if one item in a tote is a frozen items, all the remaining items in the tote are also frozen items. In other words, frozen items are placed together in the same tote. Likewise, chilled items are placed together in the same tote. Thus, a tote does not store ambient temperature items with frozen items or chilled items. Likewise, frozen items are not stored together with chilled or room-temperature items in the same tote. This assist with maintaining proper temperature of cold-chain items within each tote.

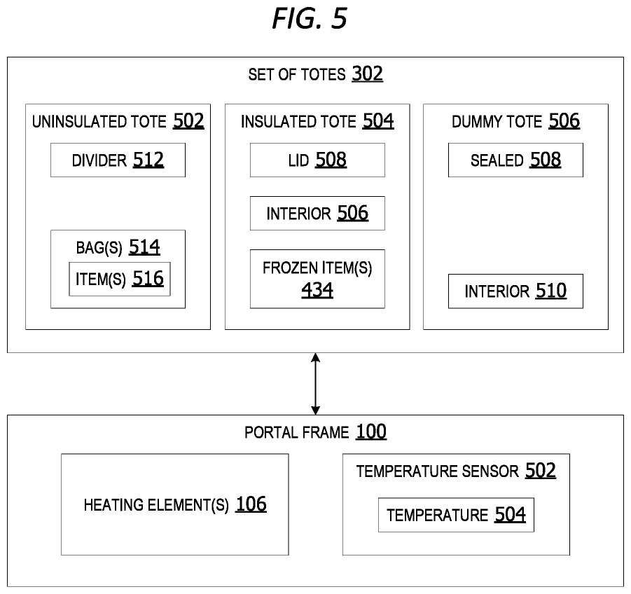

FIG. 5 is an exemplary block diagram illustrating a heated portal frame 100 including a temperature sensor 502. The temperature sensor 502 is a device for measuring a temperature 504 of the portal frame 100 or a portion of the portal frame 100. The temperature sensor 502 can be implemented as a thermometer or other temperature sensing device.

The heating element(s) 106 are activated to warm/heat the portal frame 100 or a portion of the portal frame 100 if the temperature falls outside a predetermined temperature range.

The portal frame 100 is situated over a set of totes 302, enabling user access to the contents of the set of totes while preventing removal of the set of totes from the order dispensation portal. The set of totes 302 in this example can include an uninsulated tote 502 for storing ambient temperature items and/or chilled items. The uninsulated tote 502 in this example has no lid.

The set of totes 302 includes an insulated tote 504 for storing one or more frozen item(s) 434 within an interior 506 of the insulated tote 504. The insulated tote 504 includes a lid 508 to maintain temperature of frozen items within the tote.

A dummy tote 506 is a tote that is sealed 509 to prevent user access to an interior 510 of the tote. A dummy tote may be used to fill a recessed tote compartment when the compartment is not needed for dispensing items to the user. This prevents user access to the otherwise empty tote compartment. In other words, the dummy tote is used to a place holder when the compartment is not needed to dispense items in a regular uninsulated tote or an insulated tote.

A tote can optionally include a divider 512 for dividing bag(s) 514 or other item(s) 516 within the tote from each other. A divider 512 can also be used to minimize the amount of space within the tote surrounding an item. The divider can reduce the amount of bumping, rolling or jostling of items within the tote. For example, if a single canned item is going to be placed into the tote, the divider 512 can be placed to push the can against one wall of the tote. This minimizes the amount of rolling or other movement of the canned item within the tote as the tote is moved.

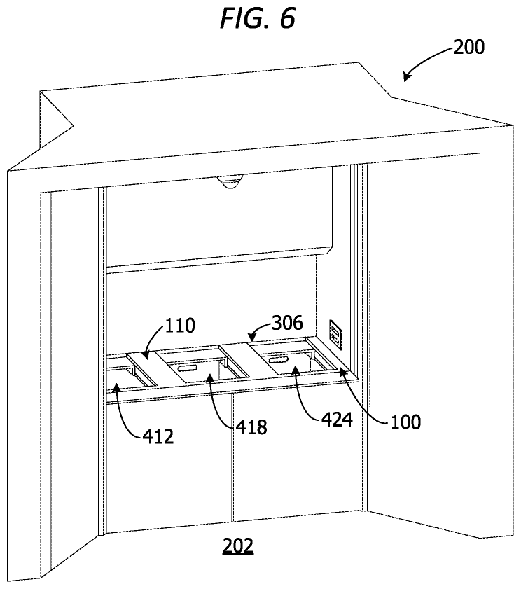

FIG. 6 is an exemplary block diagram illustrating an order dispensation portal 200 having open automatic sliding doors exposing a portal frame 100 to exterior ambient air entering the order dispensation alcove 202. The portal frame 100 in this example is a metallic frame forming a horizontal surface 306. The portal frame 100 defines three tote access portals (openings) permitting user access to three totes (not shown) located beneath the portal frame. The tote access portals in this example includes tote access portals 412, 418 and 424. The exterior surface of the portal frame 110 is in contact with ambient air when the portal doors are open.

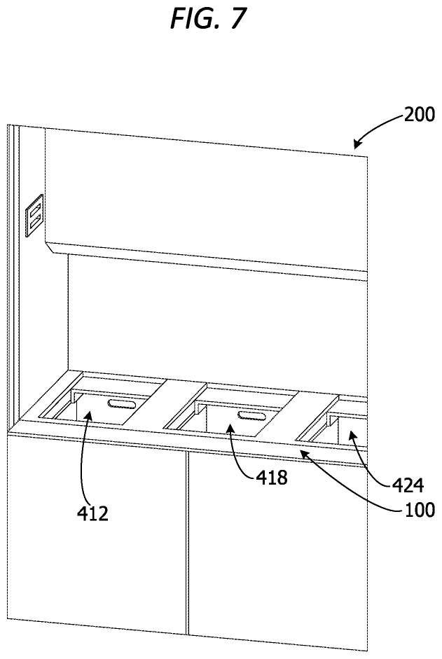

FIG. 7 is an exemplary block diagram illustrating a portal frame 100 defining three tote access ports. The order dispensation portal 200 in this example includes a set of three tote access portals within the portal frame 100. The tote access portals in this non-limiting example includes tote access portal 412, 418 and 412. In other examples, the portal frame can include a single tote access portal, as well as two or more tote access portals. Each tote access portal is situated above its corresponding tote.

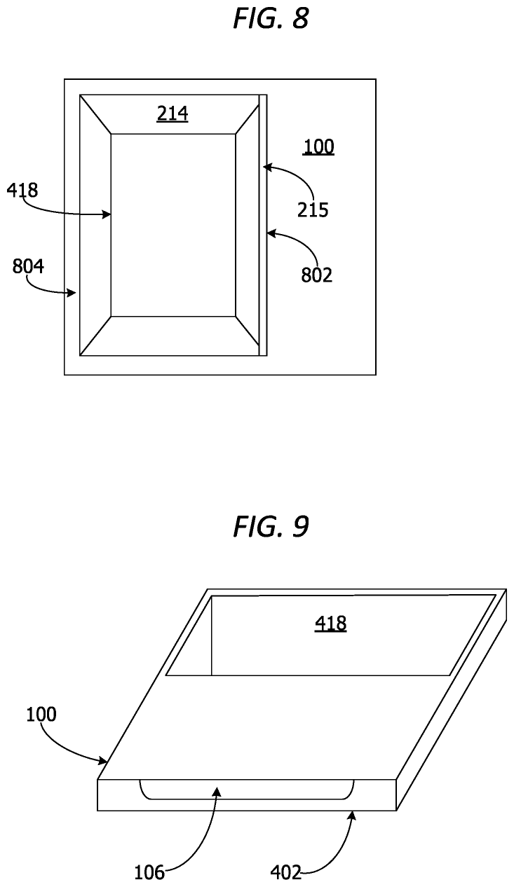

FIG. 8 is an exemplary block diagram illustrating a heated portal frame 100 defining a tote access portal 418. In this example, the portal frame includes a single tote access portal. In other examples, the portal frame defines two or more tote access portals.

The tote access portal is situated above a recessed tote compartment beneath the portal frame. A backing member 214 prevents a tote inside the tote chamber from sliding backwards out of the tote chamber. If the tote did slide backwards, the tote access portal would no longer be aligned with the opening at the top of the respective tote associated with the tote chamber beneath the portal.

A lip 215 overlaps the rim of the tote or slides into a groove running along the side of the tote to prevent the tote from being lifted out through the portal frame. The lip 215 can run along a single side 802 of the chamber or run along both sides 802 and 804.

In other examples, there is no lip 215. Instead, the tote access portal has a smaller diameter than the diameter of the opening on the tote. Therefore, the portion of the portal frame defining the edges of the tote access portal overlap with the sides/rim of the tote. In other words, the tote access portal is smaller then the width of the tote preventing the tote from fitting through the tote access portal. This secures the tote beneath the portal frame.

FIG. 9 is an exemplary block diagram illustrating a side view of a heated portal frame 100. The portal frame 100 in this example includes a single tote access portal 418. One or more heating element(s) 106 in this example is located on an underside 402 of the portal frame 100.

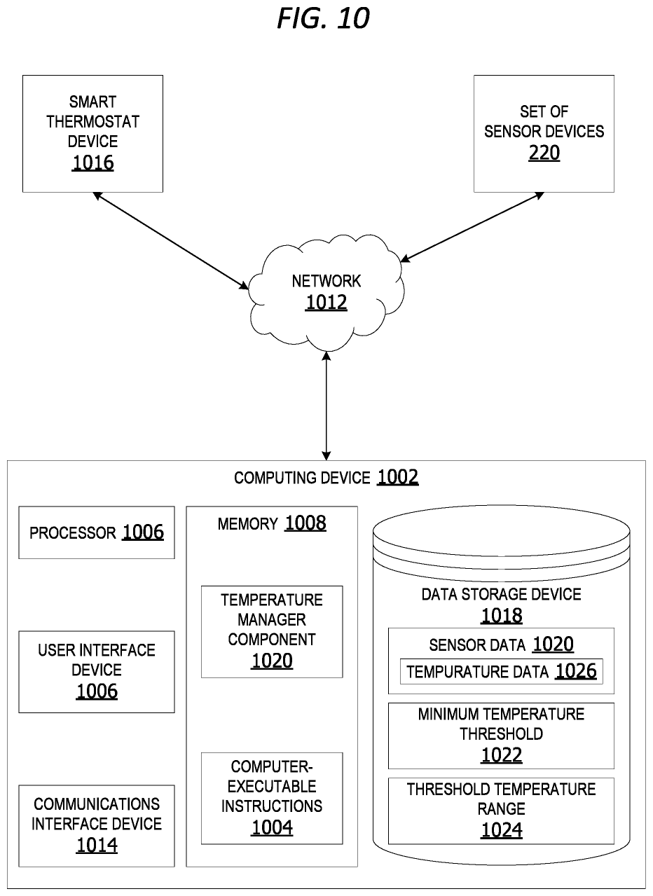

FIG. 10 is an exemplary block diagram illustrating a system 1000 for maintaining temperature of a portal frame within a threshold temperature range. In the example of FIG. 10, the computing device 1002 represents any device executing computer-executable instructions 1004 (e.g., as application programs, operating system functionality, or both) to implement the operations and functionality associated with the computing device 1002. The computing device 1002 in some examples includes a mobile computing device or any other portable device. A mobile computing device includes, for example but without limitation, a mobile telephone, laptop, tablet, computing pad, netbook, gaming device, and/or portable media player. The computing device 1002 can also include less-portable devices such as servers, desktop personal computers, kiosks, or tabletop devices. Additionally, the computing device 1002 can represent a group of processing units or other computing devices.

In some examples, the computing device 1002 has at least one processor 1006 and a memory 1008. The computing device 1002 in other examples includes a user interface component 1010.

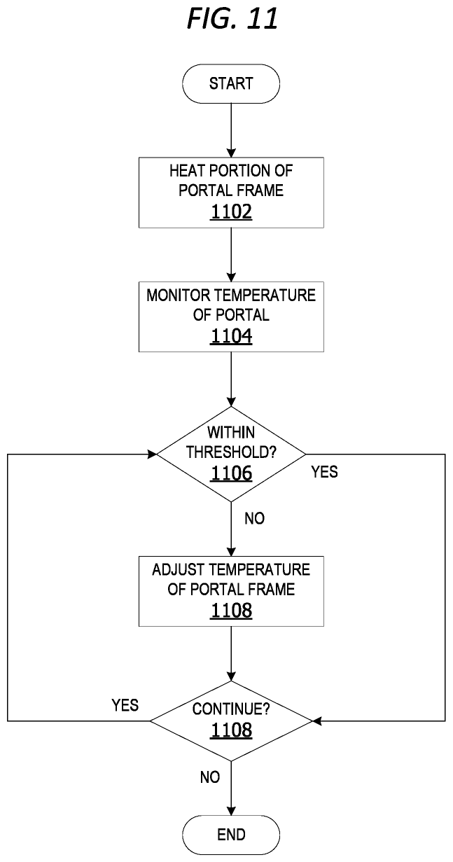

The processor 1006 includes any quantity of processing units and is programmed to execute the computer-executable instructions 1004. The computer-executable instructions 1004 is performed by the processor 1006, performed by multiple processors within the computing device 1002 or performed by a processor exterior to the computing device 1002. In some examples, the processor 106 is programmed to execute instructions such as those illustrated in the figures (e.g., FIG. 11).

The computing device 1002 further has one or more computer-readable media such as the memory 1008. The memory 1008 includes any quantity of media associated with or accessible by the computing device 1002. The memory 1008 in these examples is internal to the computing device 1002 (as shown in FIG. 10). In other examples, the memory 108 is exterior to the computing device (not shown) or both (not shown). The memory 1008 can include read-only memory and/or memory wired into an analog computing device.

The memory 1008 stores data, such as one or more applications. The applications, when executed by the processor 1006, operate to perform functionality on the computing device 1002. The applications can communicate with counterpart applications or services such as web services accessible via a network 1012. In an example, the applications represent downloaded client-side applications that correspond to server-side services executing in a cloud.

In other examples, the user interface component 1010 includes a graphics card for displaying data to the user and receiving data from the user. The user interface component 1010 can also include computer-executable instructions (e.g., a driver) for operating the graphics card. Further, the user interface component 1010 can include a display (e.g., a touch screen display or natural user interface) and/or computer-executable instructions (e.g., a driver) for operating the display. The user interface component 1010 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 1002 in one or more ways.

The network 1012 is implemented by one or more physical network components, such as, but without limitation, routers, switches, network interface cards (NICs), and other network devices. The network 1012 is any type of network for enabling communications with remote computing devices, such as, but not limited to, a local area network (LAN), a subnet, a wide area network (WAN), a wireless (Wi-Fi) network, or any other type of network. In this example, the network 1012 is a WAN, such as the Internet. However, in other examples, the network 1012 is a local or private LAN.

In some examples, the system 1000 optionally includes a communications interface component 1014. The communications interface component 1014 includes a network interface card and/or computer-executable instructions (e.g., a driver) for operating the network interface card. Communication between the computing device 1002 and other devices, such as but not limited to a smart thermostat device 1016 and/or a set of sensor devices 120, can occur using any protocol or mechanism over any wired or wireless connection. In some examples, the communications interface component 1014 is operable with short range communication technologies such as by using near-field communication (NFC) tags.

The smart thermostat device 1016 is a network enabled thermostat for controlling temperature of the portal frame and/or controlling the temperature within the order pickup alcove. The smart thermostat device in some examples is an Internet of Things (IoT) device.

The system 1000 can optionally include a data storage device 1018 for storing data, such as, but not limited to sensor data 1018, minimum temperature threshold 1022 and/or a threshold temperature range 1024. The sensor data 1020 can include temperature data 1026 associated with temperature of the order dispensation alcove and/or the portal frame.

The data storage device 1018 can include one or more different types of data storage devices, such as, for example, one or more rotating disks drives, one or more solid state drives (SSDs), and/or any other type of data storage device. The data storage device 1018 in some non-limiting examples includes a redundant array of independent disks (RAID) array. In other examples, the data storage device 1018 includes a database.

The data storage device 1018 in this example is included within the computing device 1002 or associated with the computing device 1002. In other examples, the data storage device 1018 includes a remote data storage accessed by the computing device via the network 1012, such as a remote data storage device, a data storage in a remote data center, or a cloud storage.

The memory 1008 in some examples stores one or more computer-executable components. Exemplary components include a temperature manager component 1020. The temperature manager component 1020 monitor temperature associated with the portal frame. The temperature manager component 1020 automatically adjusts a temperature of the portal frame to maintain portal frame temperature within a threshold temperature range. Maintaining portal frame temperature within the threshold temperature range prevents condensation from forming on a portion of a surface of the portal frame coming into contact with the ambient exterior air.

FIG. 11 is an exemplary flow chart illustrating operation of the computing device to automatically adjust temperature of a portal frame to prevent condensation. The process shown in FIG. 11 is performed by a temperature manager component, executing on a computing device, such as the computing device 102 in FIG. 1.

The process begins by heating a portion of a portal frame at 1102. The portal frame is heated by one or more heating elements, such as, but not limited to, the heating elements 106 in FIG. 1. The temperature manager component monitors temperature of the portal frame at 1104. The temperature manager component determines if the temperature is within a temperature threshold at 1106. The temperature threshold can be a threshold temperature range 1024 or a minimum temperature threshold 1022. If no, the temperature manager component adjusts temperature of portal frame at 1108. The temperature manager component determines whether to continue at 1110. If yes, the temperature manager component iteratively performs operations 1106 through 1110 to regulate temperature of the portal frame. When a determination is made not to continue at 1110, the process terminates thereafter.

While the operations illustrated in FIG. 11 are performed by a computing device, aspects of the disclosure contemplate performance of the operations by other entities. In a non-limiting example, a cloud service performs one or more of the operations.

### ADDITIONAL EXAMPLES

In some examples, condensation issues caused by the refrigerated chamber behind the portal doors required for maintaining cold chain for groceries is eliminated by incorporating heating elements within the portal frame, attaching heating elements to the portal frame, or otherwise including heating elements within close proximity to the portal frame. The portal frame of the pickup portal is in contact with cooled air coming from within the tote storage device. The portal frame becomes cold as a result. The cold frame would condense moisture from the outdoor air outside the portal. The portal frame is also in contact with potentially warmer air coming from outside the portal dispensation area. This causes moisture to condense on the frame. This moisture is an opportunity for corrosion, faulting electronic components, or bacterial growth. To prevent the condensation, the coldness of the frame is reduced. This is accomplished by adding insulation to the inside chamber and adding resistance heating elements to the portal frame. This heat keep the surface-contact air from condensing, thus eliminating the moisture. This ensures adequate operation of the pickup portals.

Alternatively, or in addition to the other examples described herein, examples include any combination of the following:
an order dispensation portal configured to dispense a set of partial order totes via an order pickup alcove enclosed by a set of automatic sliding doors, wherein the automatic sliding doors slide open to permit a user to access the set of partial order totes;
a portal frame forming a horizontal surface defining a set of tote access portals associated with the set of partial order totes resting within a set of recessed tote compartments, wherein the portal frame prevents a user from removing a tote in the set of partial order totes from a recessed tote compartment while permitting the user to remove contents of the tote;
a horizontal lip extending along at least one side member of at least one recessed tote compartment associated with at least one tote access portal in the set of tote access portals, wherein the lip overlaps at least a portion of at least one tote within at least one recessed tote compartment to prevent the user from removing the at least one tote from the at least one recessed tote compartment while permitting the user to remove contents of the selected tote;
insulation associated with at least a portion of the order dispensation portal providing insulation against cooled air from an interior temperature-controlled cooler area adjacent to the order dispensation portal; and
a set of resistance heating elements associated with at least a portion of the portal frame configured to increase a temperature of an external surface of the portal frame in contact with ambient exterior air, wherein the set of resistance heating elements prevents condensation on the portal frame;
a first tote access portal associated with a first tote;
a second tote access portal associated with a second tote;
a third tote access portal associated with a third tote;
a first tote access portal associated with a tote comprising at least one ambient temperature item associated with an online grocery order;
a second tote access portal associated with an insulated tote comprising at least one chilled or frozen item associated with the online grocery order;
a third tote access portal associated with a dummy tote configured to prevent the user from accessing an interior of the dummy tote;
wherein the set of resistance heating elements are embedded within the portal frame;
wherein the set of resistance heating elements are attached to an underside of the portal frame;
a temperature sensor device monitoring a temperature of the portal frame, wherein a thermostat device autonomously raises a temperature of the portal frame on condition the temperature sensor device detects a temperature of the portal frame falls below a minimum temperature threshold;
a backing member connected to the portal frame and extending downward into a recessed tote compartment preventing a tote sitting inside the recessed tote compartment from sliding backwards out of the recessed tote compartment;
a set of vents configured to provide temperature-controlled air to the order dispensation portal, wherein the ambient temperature associated with the portal frame is controlled via the set of vents to prevent condensation on the portal frame;
a set of wires providing an electric current to at least one resistance heating element in the set of heating elements;
opening a set of automatic sliding doors to permit a user to access the set of partial order totes; dispensing, by a robotic device;
the set of partial order totes within a set of recessed tote compartments below a horizontal portal frame defining a set of tote access portals;
wherein the portal frame prevents the user from removing a tote in the set of partial order totes from a recessed tote compartment while permitting the user to remove contents of the tote;
increasing a temperature of the portal frame via a set of resistance heating elements attached to at least a portion of the portal frame to increase a temperature of an external surface of the portal frame in contact with ambient exterior air,
wherein heating the portal frame prevents condensation from forming on the portal frame coming into contact with the ambient exterior air;
providing power to the set of resistance heating elements via a set of wires connected to at least one power source;
monitoring a temperature of the portal frame via at least one temperature sensor;
increasing the temperature of the portal frame via a smart thermostat device on condition the temperature sensor device detects a temperature of the portal frame falls below a minimum temperature threshold;
wherein the portal frame defines a first tote access portal associated with a first tote, a second tote access portal associated with a second tote and a third tote access portal associated with a third tote;
a metallic framework forming a horizontal surface defining a set of tote access portals, each tote access portal associated with a recessed tote compartment within a set of recessed tote compartments located beneath the metallic framework;
a lip extending along at least one side of each tote access portal in the set of tote access portals, wherein the lip overlaps at least a portion of a rim of a selected tote within a selected recessed tote compartment to prevent the user from removing the selected tote from the selected recessed tote compartment while permitting the user to remove contents of the selected tote;
a set of resistance heating elements associated with at least a portion of the portal frame configured to increase a temperature of an external surface of the portal frame in contact with ambient exterior air, wherein the set of resistance heating elements prevents condensation on the portal frame due to cooled air from an interior temperature-controlled area adjacent to the order dispensation portal; and
a backing member connected to the portal frame and extending downward into a recessed tote compartment preventing a tote sitting inside the recessed tote compartment from sliding backwards out of the recessed tote compartment.

At least a portion of the functionality of the various elements in FIG. 1, FIG. 2, FIG. 3, FIG. 4, FIG. 5, FIG. 6, FIG. 7, FIG. 8, FIG. 9 and FIG. 10 can be performed by other elements in FIG. 1, FIG. 2, FIG. 3, FIG. 4, FIG. 5, FIG. 6, FIG. 7, FIG. 8, FIG. 9 and FIG. 10, or an entity (e.g., processor 106, web service, server, application program, computing device, etc.) not shown in FIG. 1, FIG. 2, FIG. 3, FIG. 4, FIG. 5, FIG. 6, FIG. 7, FIG. 8, FIG. 9 and FIG. 10.

In some examples, the operations illustrated in FIG. 11 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of maintaining portal frame temperature, the method comprising activating a set of resistance heating elements to heat at least a portion of a portal frame forming a horizontal platform defining a set of tote access portals to increase a temperature of an exterior surface of the portal frame in contact with ambient exterior air within an order dispensation alcove area, the set of resistance heating elements associated with at least a portion of the portal frame; monitoring a temperature associated with the portal frame; and automatically adjusting a temperature of the portal frame to maintain portal frame temperature within a threshold temperature range, wherein maintaining portal frame temperature within the threshold temperature range prevents condensation from forming on a portion of a surface of the portal frame coming into contact with the ambient exterior air.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for heating a portal frame. For example, the elements illustrated in FIG. 1, FIG. 2, FIG. 3, FIG. 4, FIG. 5, FIG. 6, FIG. 7, FIG. 8, FIG. 9 and FIG. 10, such as when encoded to perform the operations illustrated in FIG. 11, constitute exemplary means for activating a set of resistance heating elements to heat at least a portion of a portal frame forming a horizontal platform defining a set of tote access portals to increase a temperature of an exterior surface of the portal frame in contact with ambient exterior air within an order dispensation alcove area, the set of resistance heating elements associated with at least a portion of the portal frame; exemplary means for monitoring a temperature associated with the portal frame; and exemplary means for adjusting a temperature of the portal frame to maintain portal frame temperature within a threshold temperature range, wherein maintaining portal frame temperature within the threshold temperature range prevents condensation from forming on a portion of a surface of the portal frame coming into contact with the ambient exterior air.

Other non-limiting examples provide one or more computer storage devices having a first computer-executable instructions stored thereon for providing portal frame temperature maintenance. When executed by a computer, the computer performs operations including activating a set of resistance heating elements to heat at least a portion of a portal frame forming a horizontal platform defining a set of tote access portals to increase a temperature of an exterior surface of the portal frame in contact with ambient exterior air within an order dispensation alcove area, the set of resistance heating elements associated with at least a portion of the portal frame; monitoring a temperature associated with the portal frame; and automatically adjusting a temperature of the portal frame to maintain portal frame temperature within a threshold temperature range, wherein maintaining portal frame temperature within the threshold temperature range prevents condensation from forming on a portion of a surface of the portal frame coming into contact with the ambient exterior air.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of” The phrase “one or more of the following: A, B, and C” means “at least one of A and/or at least one of B and/or at least one of C.”

In an exemplary embodiment, one or more of the exemplary embodiments include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system can be reduced significantly. For example, whenever localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data can include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI can be discarded depending upon the degree to which such KRI has any value based on local processing and evaluation of such KRI. In an exemplary embodiment, KRI may not even be utilized in any form if it is determined that KRI is transient and can be considered as signal noise. Furthermore, in an exemplary embodiment, the kernel rejects generic data to provide a modified kernel (“KRG”) by filtering incoming raw data using a stochastic filter that thereby provides a predictive model of one or more future states of the system and can thereby filter out data that is not consistent with the modeled future states which can, for example, reflect generic background data. In an exemplary embodiment, KRG incrementally sequences all future undefined cached kernels of data to filter out data that can reflect generic background data. In an exemplary embodiment, KRG further incrementally sequences all future undefined cached kernels having encoded asynchronous data to filter out data that can reflect generic background data.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for heating a portal frame, the system comprising:
an order dispensation portal configured to dispense a set of totes via an order pickup alcove enclosed by a set of automatic sliding doors, wherein the automatic sliding doors slide open to permit user access to contents of at least one tote in the set of totes;
a horizontal surface of the portal frame defining a set of tote access portals associated with the set of totes resting within a set of recessed tote compartments, wherein the portal frame prevents removal of a tote from a recessed tote compartment while permitting removal of contents from the tote;
insulation associated with at least a portion of the order dispensation portal providing insulation against cooled air from an interior temperature-controlled cooler area adjacent to the order dispensation portal; and
a set of resistance heating elements associated with at least a portion of the portal frame configured to increase a temperature of an exterior surface of the portal frame in contact with ambient exterior air, wherein the set of resistance heating elements prevents condensation on the portal frame.

2. The system of claim 1, wherein the portal frame defines a set of three tote access portals associated with a set of three totes positioned below the portal frame.

3. The system of claim 1, wherein the set of tote access portals further comprises:
a first tote access portal associated with a tote comprising at least one ambient temperature item associated with an online grocery order;
a second tote access portal associated with an insulated tote comprising at least one chilled or frozen item associated with the online grocery order; and
a third tote access portal associated with a dummy tote configured to prevent the user from accessing an interior of the dummy tote.

4. The system of claim 1, wherein the set of resistance heating elements are embedded within the portal frame.

5. The system of claim 1, wherein the set of resistance heating elements are attached to an underside of the portal frame.

6. The system of claim 1, further comprising:
a temperature sensor device monitoring a temperature of the portal frame, wherein a thermostat device autonomously raises a temperature of the portal frame on condition the temperature sensor device detects a temperature of the portal frame falls below a minimum temperature threshold.

7. The system of claim 1, further comprising:
a temperature sensor device monitoring a temperature of the portal frame, wherein a thermostat device autonomously raises a temperature of the portal frame on condition the temperature sensor device detects a temperature of the portal frame falls outside a threshold temperature range.

8. The system of claim 1, further comprising:
a set of vents configured to provide temperature-controlled air to the order dispensation portal, wherein ambient temperature associated with the portal frame is controlled via the set of vents to prevent condensation on the portal frame.

9. The system of claim 1, further comprising:
a set of wires providing an electric power to at least one resistance heating element in the set of heating elements.

10. A computer-implemented method for heating a portal frame associated with an order dispensation portal, the computer-implemented method comprising:
heating, by a set of resistance heating elements, at least a portion of a portal frame forming a horizontal platform defining a set of tote access portals to increase a temperature of an exterior surface of the portal frame in contact with ambient exterior air within an order dispensation alcove area, the set of resistance heating elements associated with at least a portion of the portal frame;
monitoring, by a set of temperature sensors, a temperature associated with the portal frame; and
automatically adjusting, via a thermostat device, a temperature of the portal frame to maintain portal frame temperature within a threshold temperature range, wherein maintaining portal frame temperature within the threshold temperature range prevents condensation from forming on a portion of a surface of the portal frame coming into contact with the ambient exterior air.

11. The computer-implemented method of claim 10, wherein the set of resistance heating elements are attached to an underside of the portal frame.

12. The computer-implemented method of claim 10, wherein the set of resistance heating elements are embedded within at least a portion of the portal frame.

13. The computer-implemented method of claim 10, further comprising:
opening a set of automatic sliding doors to permit user access to a set of totes within the order dispensation alcove area on condition a set of totes containing a set of items are dispensed within a set of recessed tote compartments below the portal frame for pickup, wherein the portal frame prevents removal of a tote in the set of totes from a recessed tote compartment while permitting removal of a set of items within each tote in the set of totes.

14. The computer-implemented method of claim 10, further comprising:
increasing the temperature of the portal frame via the thermostat device on condition a temperature sensor device detects a temperature of the portal frame falls below a minimum temperature threshold.

15. The computer-implemented method of claim 10, wherein the portal frame defines a first tote access portal associated with a first tote, a second tote access portal associated with a second tote and a third tote access portal associated with a third tote.

16. A heated portal frame associated with an order dispensation portal for dispensing a set of items to a user, the heated portal frame comprising:
a metallic framework forming a horizontal surface defining a set of tote access portals, each tote access portal associated with a recessed tote compartment beneath the metallic framework; and
a set of resistance heating elements associated with at least a portion of the portal frame configured to increase a temperature of an exterior surface of the portal frame in contact with exterior ambient air, wherein the set of resistance heating elements prevents condensation on the portal frame due to cooled air from an interior temperature-controlled area.

17. The heated portal frame of claim 16, wherein the set of resistance heating elements are attached to an underside of at least a portion of the portal frame.

18. The heated portal frame of claim 16, wherein the set of resistance heating elements are embedded within at least a portion of the portal frame.

19. The heated portal frame of claim 16, further comprising:
a lip overlapping at least a portion of a rim of a selected tote within a selected recessed tote compartment to prevent removal of the selected tote from an exterior side of the metallic framework while enabling access to contents of each tote in the set of totes.

20. The heated portal frame of claim 16, further comprising:
a backing member connected to the portal frame and extending downward into the recessed tote compartment preventing a tote sitting inside the recessed tote compartment from sliding backwards out of the recessed tote compartment.
